(19) United States
(12) Patent Application Publication
(10) Pub. No.: US 2013/0290184 A1
(43) Pub. Date: Oct. 31, 2013

(54) VIRTUAL SPECIFIC PURCHASING CARD

(71) Applicants: Leonardo Shapiro, Mexico City (MX); Luis Antonio Ascencio, Mexico City (MX); Sergio Rosengaus, Mexico City (MX); Antonio Rallo, Mexico City (MX); Carlos Sanchez, Mexico City (MX)

(72) Inventors: Leonardo Shapiro, Mexico City (MX); Luis Antonio Ascencio, Mexico City (MX); Sergio Rosengaus, Mexico City (MX); Antonio Rallo, Mexico City (MX); Carlos Sanchez, Mexico City (MX)

(73) Assignee: VSPC INC. Delaware

(21) Appl. No.: 13/460,405

(22) Filed: Apr. 30, 2012

(51) Int. Cl. G06Q 40/02; G06Q 20/34; G06Q 20/24

(52) U.S. Cl. 705/44

(57) ABSTRACT

Systems and methods of processing transactions via a computer network are provided. A virtual specific purchasing card server can receive a registration request to activate a virtual specific purchasing card, and can link the virtual specific purchasing card with a purchasing card associated with an acquirer network or an issuer network. The virtual specific purchasing card server can obtain restriction criteria of the virtual specific purchasing card. The restriction criteria can include a time restriction and at least one of a subject matter restriction, a geographic restriction, a product restriction, a service restriction, a merchant restriction, a value restriction, a frequency restriction, and a notification restriction. The virtual specific purchasing card server can identify a transaction corresponding to the virtual specific purchasing card, and can determine that the transaction satisfies the restriction criteria.

### BACKGROUND

Electronic or other non-cash payment schemes allow consumers to purchase goods or services using a credit card over a network such as the Internet. Credit card payments expand consumer purchasing power, as consumers can make a purchase based on a promise to pay for the purchase in the future, either in a lump sum payment or in a series of partial payments where a debt is accrued and is subject to interest. Credit cards are typically physical plastic cards that indicate the name of the consumer associated with the credit card, the name of the provider of the credit card, and a credit card number. To make a transaction, the consumer presents the credit card to a merchant or enters the credit card number into a card reader or interface of a networked computer. If the transaction is approved, the consumer is charged, and the purchased products or services are provided. The credit card can be used widely, for example with any merchant or vendor who accepts payment from the provider of the credit card.

### SUMMARY

At least one aspect is directed to a computer implemented method of processing transactions via a computer network. The method receives, at a virtual specific purchasing card server, a registration request to activate a virtual specific purchasing card. The registration request can identify at least one of an acquirer network and an issuer network. The method links the virtual specific purchasing card with a purchasing card associated with the acquirer network or the issuer network. The method obtains restriction criteria of the virtual specific purchasing card. The restriction criteria can include a time restriction and at least one of a subject matter restriction, a geographic restriction, a product restriction, a service restriction, a merchant restriction, a value restriction, a frequency restriction, and a notification restriction. The method identifies a transaction corresponding to the virtual specific purchasing card, and determines that the transaction satisfies the restriction criteria. The method can record information corresponding to the transaction in a data storage unit.

At least one aspect is directed to a system of processing transactions via a computer network. The system includes a virtual specific purchasing card server configured to communicate with an acquirer network or an issuer network and with a data storage unit. The virtual specific purchasing card server can receive a registration request to activate a virtual specific purchasing card. The registration request may identify the acquirer network or the issuer network. The virtual specific purchasing card server can link the virtual specific purchasing card with a purchasing card associated with the acquirer network or the issuer network, and can obtain restriction criteria of the virtual specific purchasing card. The restriction criteria can include a time restriction and at least one of a subject matter restriction, a geographic restriction, a product restriction, a service restriction, a merchant restriction, a value restriction, a frequency restriction, and a notification restriction. The virtual specific purchasing card server can identify a transaction corresponding to the virtual specific purchasing card, and can determine that the transaction satisfies the restriction criteria. The virtual specific purchasing card server can provide information corresponding to the transaction to the data storage unit.

At least one aspect is directed to a computer readable storage medium having instructions to process transactions via a computer network. The instructions include instructions to receive a registration request to activate a virtual specific purchasing card. The registration request may identify an acquirer network or an issuer network. The instructions include instructions to link the virtual specific purchasing card with a purchasing card associated with the acquirer network or issuer network, and instructions to obtain restriction criteria of the virtual specific purchasing card. The restriction criteria can include a time restriction and at least one of a subject matter restriction, a geographic restriction, a product restriction, a service restriction, a merchant restriction, a value restriction, a frequency restriction, and a notification restriction. The instructions include instructions to identify a transaction corresponding to the virtual specific purchasing card, to determine that the transaction satisfies the restriction criteria, and to record information corresponding to the transaction in a data storage unit.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting an example environment to process transactions via a computer network, according to an illustrative implementation;

FIG. 2 is a flow diagram depicting a method of processing transactions via a computer network, according to an illustrative implementation; and

FIG. 3 is a block diagram illustrating a general architecture for a computer system that may be employed to implement various elements of the systems and methods described and illustrated herein, according to an illustrative implementation.

### DETAILED DESCRIPTION

Following below are more detailed descriptions of various concepts related to, and embodiments of, methods, apparatuses, and systems of processing transactions via a computer network. The various concepts introduced above and discussed in greater detail below may be implemented in any of numerous ways, as the described concepts are not limited to any particular manner of implementation. Examples of specific implementations and applications are provided primarily for illustrative purposes.

A credit card can be used to purchase goods and services worldwide under a variety of conditions. For example, a credit card in the name of a user can be used by that user to purchase items up to a credit limit set by the issuer of the credit card. The credit limit can be tens of thousands of U.S. dollars, or more. The user can present the physical credit card (or provide its number into an interface of a computing device) to make a transaction. When the merchant or other seller of the product or service accepts credit cards from the entity that is the credit card issuer, the transaction is routinely authorized.

In some circumstances, the user or entity responsible for paying the balance due for a credit card can extend use of the credit card to other users. For example, an employer can provide credit cards (having the same or different numbers) to employees, a parent can authorize a child to use a credit card, or two or more people (e.g., spouses) can share a credit card. In these examples, the person or entity paying the credit card balance is not necessarily the same person who incurred charges on the credit card, and the credit card can be misused or overused due to neglect, indifference, or fraud. This can lead to credit card balances or particular purchases that are objectionable to at least one of the authorized users of the credit card.

In one implementation, a virtual specific purchasing card (“VSP card”) can be provided to a user. The VSP card can be a physical card, such as a plastic or laminated card having information encoded thereon, such as a VSP card number. The user can purchase the VSP card from a store or physical or online retail location. In a computer networked environment, the user can register the VSP card by communicating with a virtual specific purchasing card server (“VSPC server”). For example, the user can provide information about the VSP card and about one or more of the user's purchasing cards, such as credit cards, debit cards, charge cards, or cash cards. In this example, the VSPC server can link the VSPC with the user's purchasing card. The user can also provide at least one restriction criterion that places limitations on the use of the VSP card, as described further herein.

In one implementation, when linked, the user can present the VSP card at a point of sale in an attempt to make a purchase. The purchase attempt can be transmitted via a computing network for authorization and to complete the transaction. In this example, the VSPC server can identify the transaction and determine whether or not the transaction satisfies the restriction criterion associated with the VSP card. The balance due for this purchase can be applied to the user's purchasing card when the purchase, made with the VSP card, satisfies the restriction criterion. The VSPC server can also determine that the transaction fails to satisfy the criterion. In this example, the VSPC server can provide a rejection notification to decline the transaction.

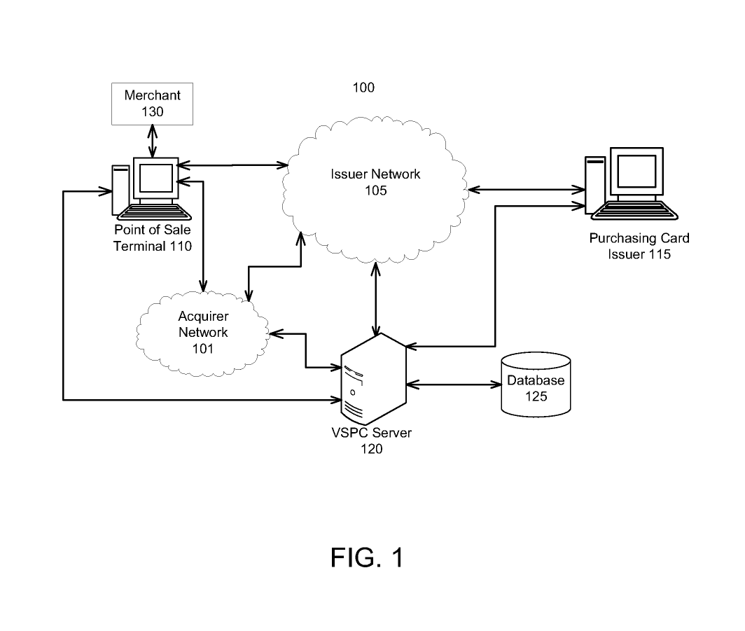

FIG. 1 illustrates an example system 100 to process transactions via at least one computer network, such as acquirer network 101 or issuer network 105. In one implementation, the system 100 processing transactions via both acquirer network 101 and issuer network 105. The acquirer network 101 and the issuer network 105 can be separate networks, partially overlapping, or part of a larger network such as the Internet. In some implementations, the system 100 includes at least one point of sale terminal 110, at least one purchasing card issuer 115, at least one virtual specific purchasing card server (“VSPC server”) 120, at least one database 125, and at least one merchant 130. In some implementations the system 100 is compliant with the Payment Card Industry Data Security Standard (PCI DSS) information security standard set forth by the Payment Card Industry Security Standards Council.

The issuer network 105 can include at least one local, metro, wide, or other area network, and can also include or be part of the Internet. In one implementation, the issuer network 105 is associated with at least one purchasing card issued by the purchasing card issuer 115. For example, the issuer network 105 can include distributed computers that form a network associated with acquirers that process purchasing cards (e.g., credit cards) that are issued by the purchasing card issuer 115. The VSP card can use the same issuer network 105 as its linked purchasing card. In some examples, the purchasing card issuer 115 can assent to use of the issuer network 105 for transactions using the VSP card, and for communication with the VSPC server 120.

The acquirer network 101 can include at least one local, metro, wide, or other area network, and can also include or be part of the Internet. In one implementation, the acquirer network 101 is associated with at least one issuing network 105. For example, the acquirer network 101 can include distributed computers that form a network associated with merchants 130 that accept purchasing cards (e.g., credit cards) that are issued by the purchasing card issuer 115. The VSP card can use the same acquirer network 101 as its linked purchasing card. In some examples, a computing device of the acquirer network 101 can assent to use of the issuer network 105 for transactions using the VSP card, for communication with the VSPC server 120, or to settle and liquidate transactions between the merchants 130 (or other vendors of goods or services) and purchasing card issuer 115.

An acquirer entity can affiliate merchants 130 with the acquirer network 101. For example, the merchant 130 can set up an account with the acquirer to receive purchasing card payments via the acquirer network 101. The acquirer network 101 can be operated by or associated with an entity having a relationship with the merchant 130 to process transactions for users such as customers of the merchant 130. The acquirer network 101 can gather authorizations from the purchasing card issuer 115 via the issuer network 105, process the transaction and compensate the merchant 130. In this example the entity operating the acquirer network 101 can charge a percentage fee for each transaction. The issuer network 105 can connect acquirer entities with the purchasing card issuer 115 and can process the transaction and compensate the merchant 130 together with the acquirer network 101, for example. In one implementation, the acquirer network 101 interacts with merchants 130 and purchasing card issuers 115 for purchase authorization and settlement purposes, and the issuer network 105 interacts with the purchasing card issuers 115 to set rules for transactions and to route transactions between the merchant 130 and the purchasing card issuer 115.

In one implementation, the issuer network 105 and the purchasing card issuer 115 can be part of a closed network system where the issuer network 105 is operated or controlled by the purchasing card issuer entity such as a financial institution or credit card company. In other implementations, the issuer network 105 and the purchasing card issuer 115 are part of an open network system where the issuer network is controlled or operated by a financial institution such as a bank that is a separate entity from the purchasing card issuer 115 such as a credit card company.

The point of sale terminal 110 can include a computing device such as a personal computer, cash register, laptop, desktop, tablet computer, or smart phone. In one implementation, the point of sale terminal 110 includes a card reader configured to identify information on the VSP card such as a VSP card number. The card reader can be a device configured to read information encoded on a magnetic strip of the VSP card, or can include an interface where the user or the merchant 130 enters the VSP card number. The card reader can also be a bar code reader that scans and reads information from the VSP card. In some implementations the point of sale terminal 110 includes a card reader device that can read both purchasing card information and VSP card information.

The point of sale terminal 110 can be located in a store or at a location of a merchant 130 offering goods or services for sale. In some implementations, a computing device capable of obtaining VSP card information and communicating VSP card information via the issuer network 105 can operate as the point of sale terminal 110 or merchant 130. The point of sale terminal 110 can include a computing device in a home, office, store, or vendor location, and can be in a fixed location (e.g., in a store) or a mobile location (e.g., a smart phone or tablet computer having VSP card or purchasing card reading capability). In one implementation, the point of sale terminal 110 is a computer configured to connect with the Internet for online purchase of goods or services.

The purchasing card issuer 115 can issue a credit card (or other purchasing card) to the user. Transactions involving the credit card can be communicated via the issuer network 105 between the purchasing card issuer 115 and the point of sale terminal 110 via an acquirer associated with the acquirer network 101 to authorize or decline the transactions. In some implementations, the point of sale terminal 110 communicates with the purchasing card issuer 115 via computing devices of the acquirer network 101 that rout transactions via the issuer network 105. For example, a user can enter VSP card information into an interface of the point of sale terminal 110 to make a purchase using the VSP card at the point of sale terminal 110. In this example, the point of sale terminal 110 communicates with the purchasing card issuer 115 via the acquirer network 101 to determine whether or not the point of sale terminal 110 is authorized to make the transaction.

The purchasing card issuer 115 can include servers or other computing devices associated with the entity that provides purchasing cards. For example, the purchasing card issuer 115 can be a credit card company or other financial institution. Servers, data storage units, or other computing devices of the purchasing card issuer 115 can include information about users and their purchasing cards or financial institution accounts. The purchasing card issuer 115 may include a plurality of servers as part of a server farm or data center. The purchasing card issuer 115 can communicate with (or its computing devices can be part of) the issuer network 105, for example to communicate with the point of sale terminal 110 via the acquirer network 101 to authorize or decline transactions involving the purchasing card. In some implementations, the VSP card can indicate compatible purchasing card issuers 115. For example, the VSP card can indicate that it can be used to link with purchasing cards issued by a particular company, bank, or financial institution, or with a particular issuer network 105 or acquirer of acquirer network 101.

The VSPC server 120 can include at least one computing device having one or more processors or other logic units configured to evaluate VSP card activity. The system 100 can include a plurality of VSPC servers 120 that may be part of one or more server farms or data centers. In one implementation, the VSPC server 120 is a virtual server. For example, the VSPC server can be a virtual server that is part of a physical server of the purchasing card issuer 115 or a computing device (e.g., server) of the acquirer network 101.

The VSPC server 120 can execute instructions and process information associated with VSP cards and their use by a user. For example, a user can order a VSP card online by using a computing device to communicate with the VSPC server 120 to request a VSP card. This communication may take place via the Internet (or the acquirer network 101 or the issuer network 105). The user can also obtain a VSP card by purchasing one at a store, or receiving one as part of a promotion. In one implementation, responsive to a user request, the VSP card can be customized to indicate the name of the user. The VSP card can include an identification number and an expiration date. This information can be printed on the VSP card (e.g., in raised or flat lettering), or can be encoded and stored on the VSP card (e.g., as a magnetic strip, bar code, or other machine readable representation of data). In one implementation the VSP card obtained by the user is a physical card, such as a plastic card having dimensions of approximately 1.5×2.0 inches. In one implementation, the VSP card is compliant with the ISO/IEC 7810 ID-1 industry standard that indicates one example of physical characteristics of identification cards. The VSP card may also include a bar code or a Quick Response (QR) code having computer readable information encoded therein. The information on the VSP card can uniquely identify an individual VSP card. In this example, VSP cards can have unique identification numbers. In some implementations, different VSP cards can have the same identification number (or other non-numeric or alphanumeric identifier). For example, a group of employees, families, friends, or other organizations can obtain VSP cards having the same identification characteristics, such as a folio identifying the VSP cards as belonging to a common group.

In one implementation, a user can obtain at least one VSP card and associate the VSP card with a purchasing card such as the users credit card. In this example, the VSP card can be used in lieu of the purchasing card. For example, with the VSP card associated with the purchasing card, the user can purchase a good or service by presenting or using the VSP card without presenting the purchasing card. The user can add time, location, value, use, or other rules or restrictions on the use of the VSP card. When the VSP card is presented, the purchase can be authorized when the transaction complies with the restrictions of the VSP card, and can be declined when the transaction violates the restrictions. The charge for the purchased goods or services in this example can be applied to the purchasing card invoice (e.g., a monthly statement or bill) together with other purchased made using the VSP card as well as purchased made using the purchasing card.

In some implementations, the VSPC server 120 receives a registration request to activate a VSP card. For example, a user has obtained a VSP card and wishes to activate the VSP card so that it may be used. The VSPC server 120 can receive the registration request from a computing device being used by the user. This request can be received by the VSPC server 120 from the user via the Internet or other network. The registration request can identify the VSP card, the user, and at least one purchasing card associated with the user, such as the user's credit card, that is associated with the acquirer network 101 or the issuer network 105. In one implementation, the user communicates a VSP card registration request (e.g., via the acquirer network 101 or the issuer network 105) with the purchasing card issuer 115. In this example, the VSPC server 120 can receive the user's request to register the VSP card via the purchasing card issuer 115 or the acquirer network 101. The registration request, for example, indicates intent by the user to associate the VSP card with at least one purchasing card so that the VSP card can be presented to purchase goods or services, with the bill applied to the balance of the associated purchasing card.

In some implementations, the VSPC server 120 links the VSP card with the purchasing card, such as a credit card associated with the issue network 105 and with the purchasing card issuer 115. For example, the VSPC server 120 can communicate with the purchasing card issuer 115 via the acquirer network 101 or the issuer network 105 to authorize the VSP card for use as a surrogate of the purchasing card. In this example, the VSP card can be used in a transaction to purchase goods and services, with the cost of a successful transaction applied to the balance of the purchasing card.

In one implementation, the VSP card user accesses the VSPC server 120 via the Internet to register the VSP card and link it with at least one purchasing card. For example, the user can access a web page associated with the VSPC server 120 to register a VSP card by opening a new account or modifying an existing account. The VSPC server 120, via the web page can present an interface (e.g., link or button) for the user to click on to open an account. Terms and conditions of use can be provided to and accepted by the user, and the user can input information identifying the user and the VSP card. The VSP card can be identified from its card number, QR code, or a folio such as an edition number that may be used to register a group of common VSP cards with one or more purchasing cards. The user can select or identify an issuer network 105, the purchasing card issuer 115 associated with a purchasing card, or the purchasing card itself and request registration of the VSP card. The VSPC server 120 can accept the registration request and link the VSP card with the purchasing card so that the VSP card can be used on the issuer network for transactions with the purchasing card issuer. Once registered, the VSPC server 120 can communicate with the user (e.g., via email or text message to a computing device) to inform the user that a VSP card is linked with one of the user's purchasing cards.

In one example, the VSPC server 120 receives a request to link a VSP card with a purchasing card from the user who has both the VSP card and the purchasing card. The VSPC server 120 can communicate this request to the purchasing card issuer 115. The VSPC server 120 can then receive from the purchasing card issuer 115 approval to link the purchasing card with the VSP card. In one implementation a VSP card that is linked with a purchasing card associated with the acquirer network 101 or the issuer network 105 can be used at any point of sale terminal 110 authorized to process transactions for the purchasing card. In this example, the VSP card can be used at points of sale terminals 110 that are part of the acquirer network 101 or the issuer network 105 associated with the purchasing card, without presenting the purchasing card.

In some implementations, the VSPC server 120 creates an account for the user. The account can have an account number and can identify the user, e.g., by name, address, birthday, account number, social security or national identity card number. The account can indicate VSP card numbers and purchasing card numbers associated with the user, as well as in indication of which VSP cards are linked to which purchasing cards. Information indicating restriction criteria applied to VSP cards can also be included in the account. The account and account information can be stored in at least one database 125 associated with the VSPC server 120. In one implementation, the user can access his or her account to view, update, or adjust account information. For example, the user can add or remove VSP cards, purchasing cards, or restriction criteria. The database 125 can be a memory storage unit that is part of the VSPC server 120 or a separate storage device in electrical communication with the VSPC server 120. In one implementation the database 125 includes physical memory storage configured to temporarily hold data such as a buffer.

In some implementations, the VSP card is associated with at least one restriction criterion. Restriction criteria can be provided to the VSPC server 120 by the user, by the purchasing card issuer 115, or by an acquirer associated with the acquirer network 101 and stored in the database 125 as part of the user's account. The VSPC server 120 can associate the restriction criteria with the VSP card. The restriction criteria generally indicate limitations on transactions that can be made using the VSP card. For example, restriction criteria on the use of a VSP card can include time restrictions, subject matter restrictions, mode of purchase restrictions, geographic restrictions, product restrictions, service restrictions, merchant restrictions, value restrictions, frequency restrictions, or notification restrictions.

For example, a time restriction can indicate time periods when the VSP card is authorized (or not authorized) for use. The time restriction criteria can be for a fixed time period, periodic, or patterned. For example, the time restriction criteria can indicate that the VSP card can be used to purchase goods and services from Monday through Friday, or only on weekends, or during certain times of day, such as before 8:00 pm; or from 12:00 pm-2:00 pm on weekdays. The time restriction criteria generally indicate when the VSP card is authorized for use, or when the VSP card is not authorized for use. In one implementation, the time restriction is the expiration date of the VSP card.

The VSPC server 120 can also obtain at least one subject matter restriction. For example, the subject matter restriction criteria can indicate that the VSP card is authorized to purchase goods and not services, or services and not goods. Subject matter restriction criteria can limit VSP card transactions to certain subject matter, or prevent transactions involving subject matter such as age sensitive products or services, e.g., alcohol, tobacco, pharmaceuticals, prescription or non-prescription drugs, adult content products or services, or gambling related products or services. Restriction criteria such as subject matter restrictions can be in the form of a black list where the VSP card can be used to purchase everything except subject matter on the black list; or in the form of a white list, where only subject matter indicated by the subject matter criteria can be purchased with the VSP card.

Restriction criteria can also include at least one geographic restriction that identifies geographical areas (e.g., city, state, region, or country) where the VSP card can (or cannot) be used to purchase goods or services. The product restriction criteria can limit VSP card transactions to (or prevent transaction involving) products such as groceries, educational materials (e.g., books), consumer items, televisions, gaming units, audio, video, or computer devices, or travel expenses such as gasoline or tickets for plane, train, or vehicular transportation. Service restriction criteria can limit VSP card transactions to, or prevent transactions involving services such as food, food but not alcohol, tickets for an entertainment, gambling expenses, groceries, repair services, utility bills, or travel expenses such as gasoline or tickets for plane, train, or vehicular transportation for example.

In some implementations, the VSPC server 120 obtains merchant restriction criteria that identify merchants 130 authorized or not authorized to complete transactions using the VSP card. The merchant restriction criteria can identify individual merchants 130 such as individual stores, online retailers, chains, or franchises that the user indicates are acceptable merchants 130 for VSP card transactions. Restriction criteria can also include value restrictions, such as a monetary limit on individual VSP card transactions (e.g., $100, $1000), or a monetary limit on transactions during a time period, (e.g., $500 per day or $1000 per month). Additional examples of restriction criteria include frequency restrictions that limit use of the VSP card to once (or any other number of times) per day, week, or month, or a requirement that the VSP card can only be used for a single transaction within a 45 minute (or other time period) interval. In one implementation the frequency restriction set a finite limit on the number of transactions before the VSP card deactivates. For example, the VSP card can be used once, or ten times (or another number) before it becomes invalid.

The restriction criteria can also include at least one notification restriction. For example, the VSPC server can be configured to notify a user associated with the VSP card of a transaction by sending an email alerting the user to the transaction. The user can include the person making the transaction or another person. For example, two or more people can share a purchasing card such as a credit card that is linked with at least one VSP card. In this example, one of the two people can use the VSP card, and the VSPC server 120 can provide an email, short message service text message, or other notification to either or both of the two people notifying them of VSP card use.

In some implementations, more than one restriction criterion is applied to the VSP card. For example, the VSP card can include both a time restriction, a location restriction, and a value restriction. In this example, the user of the VSP card may be planning a vacation from the United States to Mexico. The user can provide restriction criteria (e.g., via the Internet, the acquirer network 101, or the issuer network 105) to the VSPC server 120 to restrict authorized use of the VSP card to the geographic area of Mexico (or a particular city or resort in Mexico) and to the time period when the user will be physically present in Mexico, such as during a one week vacation. The value restriction can limit use of the VSP card to, for example, $200 per day. In this example, the user can leave the purchasing card linked to the VSP card in a secure location at home, and can bring the VSP card on vacation, where the VSP card can be used by the user during the vacation. In this example, the restriction criteria mitigate fraudulent use should the VSP card be lost or stolen while the user is on vacation. This is an example, and other restriction criteria and combinations of two or more restriction criteria can be obtained by the VSPC server 120 and applied to the VSP card. In this example, the VSP card can be a disposable card obtained by the user for a vacation or other limited time period.

The restriction criteria associated with a VSP card linked with a purchasing card can allow a user to purchase goods and services with the VSP card with a reduced risk of financial loss due to misuse. For example, the purchasing card linked with the VSP card need not be provided to a merchant 130 at the point of sale terminal 110. If, for example, the VSP card is lost, stolen, or misused, the misuse can be limited by the restriction criteria. In one implementation, the restriction criteria of the VSP card is more limiting than restriction criteria of the purchasing card. For example, the VSP card can have a credit limit that is less than the credit limit of a credit card, or the VSP card can have a shorter validity period prior to an expiration date (e.g., days, weeks, or months) than the expiration date of the purchasing card (e.g., years). Thus, the risk of financial loss due to VSP card misuse can be less than the risk of financial loss due to purchasing card misuse. Further, should the VSP card be lost or stolen, the VSPC server 120 or the purchasing card issuer 115 can cancel the VSP card without cancelling the linked purchasing card. In one example, the VSP card does not indicate or identify what if any purchasing cards are linked with the VSP card, e.g. the VSP card number is different than the purchasing card number and the purchasing card number is not encoded on the VSP card in this example. In another example, the VSP card has an encoded or encrypted representation of the purchasing card number.

In some implementations, the restriction criteria are stored in the database 125 and accessed by the VSPC server 120. Restriction criteria can also be indicated on the VSP card, for example encoded on a magnetic strip or bar code of the VSP card. In one implementation, the purchasing card issuer 115 obtains the restriction criteria. The restriction criteria can be provided to the VSPC server 120 by any user associated with the VSP card or a purchasing card linked to the VSP card, by the purchasing card issuer 115, or by a merchant 130 associated with the point of sale terminal 110. For example, a merchant 130 associated with the point of sale terminal 110 of the acquirer may accept VSP cards only during certain times of day (e.g., time restriction) or only for transactions under a certain amount (e.g., value restriction).

In one implementation, the restriction criteria are applicable to the VSP card and not to the purchasing card. For example, a VSP card may lack authorization for a transaction based on at least one restriction criterion, and the purchasing card may be unencumbered by the restriction criterion. In this example, the VSP card cannot complete a transaction because doing so would violate a restriction criterion, and the purchasing card can complete the same transaction because the restriction criterion does not apply to the purchasing card.

In some implementations, the VSPC server 120 identifies at least one transaction corresponding to the VSPC card. The transaction can include a request from the point of sale terminal 110 to authorize a transaction using the VSP card. For example, the VSPC server 120 can receive an indication that a user is attempting to purchase a good or service with the VSP card at the point of sale terminal 110. Continuing with this example, upon presentation of the VSP card, the point of sale terminal 110 can communicate with the purchasing card issuer 115 via the acquirer network 101 or the issuer network 105 to request authorization for the transaction. The VSP card in this example is linked with the purchasing card (e.g., credit card) issued by the purchasing card issuer 115 and associated with the issuer network 105. When the transaction is authorized by the purchasing card issuer 115, and completed at the point of sale terminal 110, the monetary balance due for the transaction can be applied to the purchasing card.

In one implementation, the VSPC server 120 identifies the transaction by intercepting or receiving the communication requesting authorization of the transaction from the point of sale terminal 110. The VSPC server can also identify the transaction by receiving a communication from the purchasing card issuer 115 directly or via an acquirer, for example via the acquirer network 101 or the issuer network 105.

In some implementations, the VSPC server 120 determines whether or not the transaction satisfies any restriction criteria associated with the VSP card. For example, the VSPC server 120 can determine that the transaction satisfies (or does not satisfy) the restriction criteria. In this example, the VSPC server 120 can evaluate the transaction to identify information associated with the transaction, such as the time, location, nature, or value of the transaction, as well as additional information such as the time period between the transaction and a previous transaction, (e.g., the number of minutes or days since the previous authorized or declined transaction).

The VSPC server 120 can compare the transaction and associated information with the restriction criteria. With reference to the above vacation example, the VSPC server 120 can identify a VSP card transaction from a point of sale terminal 110 located at a Mexican beach resort, during the vacation time period, for $100. In this example, the VSPC server 120 determines that the transaction satisfies the geographic (e.g., Mexico), time (e.g., during the defined vacation period), and value (e.g., less than $200 per transaction) restriction criteria.

The VSPC server 120 can communicate (e.g., via the acquirer network 101 or the issuer network 105) with the purchasing card issuer 115 or the point of sale terminal 110 to indicate that the restriction criteria is satisfied. For example, the VSPC server 120 can provide an authorization notification to the point of sale terminal 110, to an acquirer of the acquirer network 101, or to the purchasing card issuer 115 to authorize continued processing of the transaction by the purchasing card issuer. The authorization notification can be provided via the issuer network. Responsive to this notification the purchasing card issuer 115 can authorize the transaction, which may be completed at the point of sale terminal 110 or at an acquirer of the acquirer network 101. In some implementations, the VSPC server 120 and the purchasing card issuer 115 both authorize the transaction in order for the transaction to be completed at the point of sale terminal. For example, the VSPC server 120 can authorize the transaction responsive to a determination that the restriction criteria are satisfied, and the purchasing card issuer 115 can authorize the transaction when additional purchasing card issuer criteria (e.g., credit limits, purchasing card expiration date) are satisfied. In one implementation, the purchasing card issuer 115 first provides an indication to the VSPC server 120 (e.g., directly or via the acquirer network 101) that the transaction is authorized, and the VSPC server 120 then evaluates the transaction to determine whether or not the restriction criteria are satisfied. In some implementations, the VSPC server 120 first provides an indication that the restriction criteria are satisfied, and the purchasing card issuer 115 then evaluates the transaction to determine whether or not the transaction is authorized. If the restriction criteria are satisfied, the VSPC server 120 can indicate to the point of sale terminal 110 or to the purchasing card issuer 115 that the transaction is authorized. In one implementation, if the restriction criteria are satisfied, the VSPC server 120 indicates to an acquirer of the acquirer network 101 that the transaction is authorized.

In some implementations, the VSPC server 120 evaluates a transaction and the restriction criteria and determines that the transaction fails to satisfy the restriction criteria. Again referring to the above vacation example, the VSPC server 120 could determine that a transaction is for $300, which violates the value restriction criterion, or that the transaction occurred outside the vacation time period and violates the time restriction criterion. In these examples, the VSPC server 120 can generate a notification that the transaction violates at least one restriction criterion of the VSP card. The VSPC server 120 or the purchasing card issuer 115 can decline the transaction based on this failure to satisfy the restriction criterion. For example, the VSPC server 120 can provide a rejection notification to the purchasing card issuer 115 or to the point of sale terminal 110 indicating that the transaction is rejected and will not be completed. In another example, the VSPC server 120 provides a rejection notification to an acquirer of the acquirer network 101 indicating that the transaction is rejected and will not be completed. The transaction and associated information (e.g., time, date, location, or value of the transaction), the restriction criteria, and an indication that the transaction satisfies or fails to satisfy the restriction criteria can be stored in the database 125.

The restriction criteria can be adjusted. For example, the user can communicate with the VSPC server 120 using a computing device (e.g., computer, tablet, smart phone, or laptop) via the Internet or the issuer network 105 to add, remove, adjust, or update restriction criteria of a VSP card. For example, once returning from vacation, the user of the VSP card can remove geographic or time restriction criteria from the VSP card that were associated with the vacation. The VSPC server 120 can receive the request to change the restriction criteria and can adjust the restriction criteria accordingly. In some implementations, the VSPC server 120 receives a request to adjust restriction criteria from the purchasing card issuer 115 or from an acquirer via the acquirer network 101.

In some implementations, the VSPC server 120 links the VSP card with more than one purchasing card. For example, one VSP card can be linked with a first purchasing card associated with a first issuer network 105 and first purchasing card issuer 115, and with a different second purchasing card associated with a second issuer network 105 and a second purchasing card issuer 115. The VSPC server 120 can obtain different restriction criteria for each purchasing card. For example, the VSP card can have a first frequency restriction for VSP card purchases corresponding to the first purchasing card, and a second frequency restriction, or a different restriction such as a geographic restriction, for VSP card purchases corresponding to the second purchasing card. In one implementation, the same restriction criteria can be applied to the VSP card for more than one purchasing card.

In one example, the VSPC server 120 can link the VSP card with two different credit cards or other purchasing cards. The purchasing cards can be part of the same issuer network 105 or different issuer networks 105. In this example, the VSP card can be presented at the point of sale terminal 110 to make a purchase and if the restriction criteria are satisfied and the transaction is approved the balance due for the purchase can be applied to either of the two credit cards. In some implementations, the credit cards (or other purchasing cards) are associated with characteristics, and the VSPC server 120 can select one of the two credit cards to use for the transaction based on the characteristics. The characteristics of the credit (or other purchasing) cards can include the dates that mark the beginning and end of the billing cycles. For example the billing cycle of the first credit card can be from the 1^{st} day to the last day of the month, and the billing cycle of the second credit card can be from the 15^{th} day of the month to the 14^{th} day of the next month. In this example, the VSPC server 120 can select the purchasing card to associate with the transaction based at least in part on the day of the billing cycle when the VSP card is presented. For example, a VSP card transaction on the 2^{nd} of the month can be applied to the first purchasing card, because there is a longer time period before the invoice of the first purchasing card is due, relative to the second purchasing card invoice.

Other purchasing card characteristics include credit limits of the purchasing cards, existing balances of the purchasing cards, interest rates of the purchasing cards, or reward benefits such as cash back offers, airplane tickets, hotel stays offered by the purchasing card issuers 115 to incent use of their purchasing cards. Based on purchasing card characteristics, the VSPC server 120 can select one of the purchasing cards for a transaction that offers increased benefits, monetary savings, or other advantages to the user relative to any other purchasing cards linked with the VSP card. The VSPC server 120 can obtain the characteristics from the database 125, the purchasing card issuer 115, or the point of sale terminal 110 via acquirer network 101 or issuer network 105 communication.

In one implementation with the VSP card linked to more than one purchasing card, the VSPC server 120 identifies a characteristic associated with a first purchasing card and determines that the characteristic is not available with the other purchasing cards linked with the VSP card. In this example, the VSPC server 120 selects the first purchasing card based on the characteristic and authorizes the transaction via the acquirer network 101 or the issuer network 105 with the selected first purchasing card. This authorization may be subject to purchasing card authorization by the purchasing card issuer 115 to complete the transaction at the point of sale terminal 110.

In some implementations, more than one VSP card can be linked with one issuer network 105. For example, the user may have VSP cards, each associated with one purchasing card issuer 115 and corresponding issuer network 105. In this example, multiple VSP cards can be used, with the balance due for purchases from any of the multiple VSP cards being applied to one credit card. The group of VSP cards can share the same VSP card number and other identifying information (e.g., VSP card expiration date) or each VSP card of the group can have individual VSP card numbers. The VSPC server 120 can obtain restriction criteria for the group of VSP cards. In one implementation, the restriction criteria for the group of VSP cards linked with one issuer network 105 is the same for each VSP card of the group. For example, an employer can obtain a group of VSP cards, each linked to one company purchasing card (e.g., a corporate credit card account). The VSP cards can be distributed to employees of the company. In this example, one of the users such as an authorized company representative can provide restriction criteria to the VSPC server 120 for the group of VSP cards. The restriction criteria can indicate, for example, that use of the VSP cards is limited to travel expenses, (e.g., a subject matter restriction) or food purchases (e.g., a service restriction). In some implementations, the VSPC server 120 can receive from an authorized user an adjustment to the restriction criteria particular to one of the VSP cards. For example, one employee may be travelling for business, and the restriction criteria of the VSP card assigned to that employee can be adjusted to add a time restriction that authorizes additional or different transactions during the time period of the business trip. This employer/employee use of VSP cards is an example, and group use of VSP cards can apply to other groups as well, such as families, industry associations, volunteer associations, clubs, groups of friends other social networks or organizations.

In one example, the user presents the VSP card at the point of sale terminal 110. The point of sale terminal 110 communicates with the VSPC server 120 (e.g., via the acquirer network 101 or bypassing the acquirer network 101) to request authorization for the transaction. The communication can identify the VSP card or the linked purchasing card (e.g., by issuer identification number such as BIN number or range) being presented by the user. The VSPC server 120 can approve or deny the transaction based on the restriction criteria. If the transaction is approved by the VSPC server 120, the VSPC server 120 can communicate via the acquirer network 101 or the issuer network 105 with the purchasing card issuer 115 to request the purchasing card issuer's approval for the transaction. The purchasing card issuer 115 (or an acquirer of the acquirer network 101) can communicate with the VSPC server 120 to approve or deny the transaction, based for example on credit limits or expiration dates of the purchasing card. The VSPC server 120 can communicate this approval or denial to the point of sale terminal 110 to complete or cancel the transaction. This communication can bypass the acquirer network 101 or occur via the acquirer network 101. In this closed network example, the VSPC server 120 acts as an intermediary between the point of sale terminal 110 and the purchasing card issuer 115 where the point of sale terminal 110 and the purchasing card issuer 115 communicate with the VSPC server 120 and not directly with each other.

In another example, the user presents the VSP card at the point of sale terminal 110. The point of sale terminal 110 communicates via the acquirer network 101 or the issuer network 105 with the purchasing card issuer 115 to request authorization for the transaction. The purchasing card issuer 115 can route the request (e.g., via a network switch or acquirer of the acquirer network 101) to the VSPC server 120 for approval or denial. The VSPC server 120 can approve or deny the transaction based for example on restriction criteria of the VSP card. If the transaction is approved, the VSPC server 120 communicates the approval via the acquirer network 101 or the issuer network 105 to the purchasing card issuer 115 for approval or denial based on features of the linked purchasing card. This approval or denial can be communicated back to the VSPC server 120 via the acquirer network 101 or the issuer network 105 and forwarded to the point of sale terminal 110. In this open network example, the authorization request from the point of sale terminal 110 is routed via the acquirer network 101 or the issuer network 105 through the purchasing card issuer 115 to the VSPC server 120.

Providing a VSP card to a user that can be linked with a purchasing card and used to purchase goods and services via the issuer network 105 empowers the user to decide how the VSP card can be used. Consumers (e.g., users of the VSP card), merchants associated with point of sale terminals 110, and the purchasing card issuers who accept VSP cards benefit from the flexible purchasing power offered by VSP cards. By presenting the VSP card for a financial transaction in lieu of its linked purchasing card, the VSP card (and the VSPC server 120) act as a control device that runs on top of the purchasing card through the acquirer network 101 or the issuer network 105 and maps purchasing cards to VSP cards to define how, where, and when charges can be applied to the purchasing card from use of the VSP card. A purchasing card user, e.g., the person responsible for paying the purchasing card bill, can include a parent or employer who empowers children or employees to use the VSP card under select circumstances. For example, a child can use a VSP card having restriction criteria limiting VSP card use to Mondays, Wednesdays, and Fridays (e.g., when the child has an after school event) between 6:00 pm and 9:00 pm at a defined location, with a $10 per transaction limit and a $100 monthly limit. In another example, an employee can use the VSP card to purchase office supplies during business days and hours, or for transportation expenses (e.g., a taxi) in a defined city such as New York City up to a limit of $30 per transaction.

In some implementations the VSPC server 120 receives transactions via the issuer network 105, evaluates restriction criteria, and generates a new transaction via the acquirer network 101. The point of sale terminal may, but need not connect directly (e.g., bypassing the acquirer network 101 or the issuer network 105) with the VSPC server 120. In one example, the VSPC server 120 communicates with the purchasing card issuer 115 via the issuer network 105. In some implementations, the VSPC server 120 resides as a physical or virtual server within at least one of the acquirer network 101, the issuer network 105, or the purchasing card issuer 115.

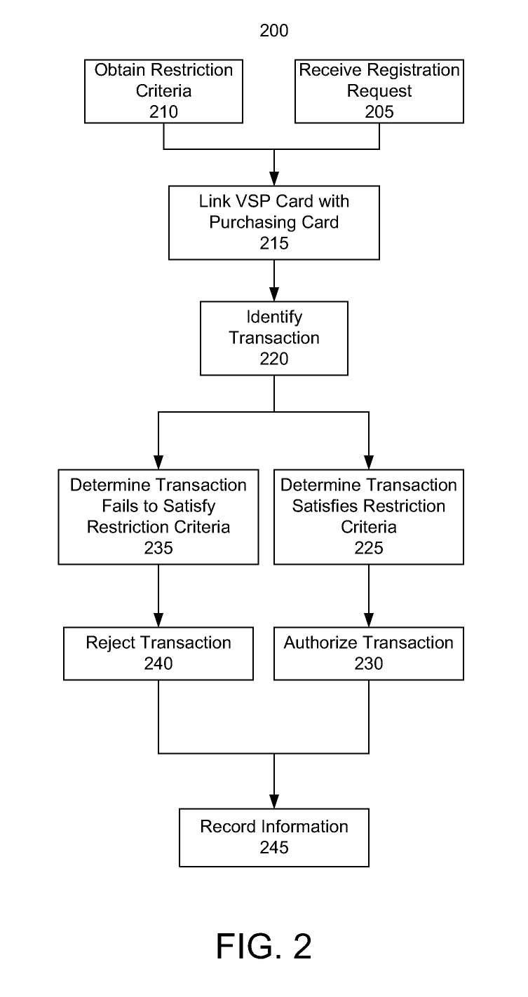

FIG. 2 illustrates a flow diagram depicting a method 200 of processing transactions via a computer network, according to an illustrative implementation. In one implementation, the method 200 is embodied in a computer readable storage medium having instructions to process transactions via a computer network. The computer readable storage medium can be included within an actual or virtual VSPC server.

The method 200 can include an act of receiving a registration request to activate a VSP card (ACT 205). The request to activate the VSP card can be received (ACT 205) by the VSPC server via the Internet, the acquirer network, or the issuer network. The received request can identify the VSP card (e.g., by indicating the VSP card number), the user, and at least one purchasing card such as a credit card.

The method 200 can also include an act of obtaining restriction criteria (ACT 210). For example, the VSPC server can receive a registration request (ACT 205) that includes an indication of restriction criteria (ACT 210). The restriction criteria obtained by the VSPC server can indicate limitations, restrictions, or conditions for use of the VSP card. For example, time, location, value, or frequency of use restriction criteria can be obtained (ACT 210) by the VSPC server and associated with the VSP card. The restriction criteria can be received (ACT 210) via the Internet, the acquirer network, or the issuer network. In one implementation, the method 200 obtains adjusted restriction criteria (ACT 210). For example, an authorized user of the VSP card or of the purchasing card, such as the recipient of the purchasing card invoice, can add, remove, or change the restriction criteria associated with the VSP card.

Restriction criteria of more than one VSP card can be obtained (ACT 210). For example, the VSPC server can obtain one set of restriction criteria for a group of VSP cards, where the VSP cards of the group are linked with one purchasing card. This set of restriction criteria can be modified for the VSP cards of the group, or individual restriction criteria can be added to or removed from a subset of the VSP cards of the group.

In some implementations, the method 200 includes an act of linking the VSP card with the purchasing card (ACT 215). For example, the VSPC server can link the VSP card with the purchasing card (ACT 215) by creating an account for a user associated with both the VSP card and the purchasing card. The account can indicate that the VSP card is associated or linked with the purchasing card so that the balance of purchases made by using the VSP card is applied to the purchasing card invoice, for example at the next billing cycle. In one implementation, linking the VSP card with the purchasing card (ACT 215) authorizes use of the VSP card on at least one acquirer network or issuer network associated with the purchasing card. For example, when the restriction criteria associated with the VSP card are satisfied, the VSP card can be used in lieu of (e.g., without presenting) the purchasing card at a point of sale terminal. The account can also indicate the obtained restriction criteria that identify conditions for use of the VSP card.

In one implementation, the virtual specific purchasing card can be linked (ACT 215) with a plurality of purchasing cards. In this example, the plurality of purchasing cards can use different acquirer or issuer networks to authorize sales. For example, the point of sale terminal can communicate with different networks to process transactions using a VSP card linked to purchasing cards of different purchasing card issuers, such as different credit card companies.

In one implementation, the method 200 includes an act of identifying a transaction (ACT 220). For example, the VSPC server can identify a transaction corresponding to the VSPC card (ACT 220). The identified transaction (ACT 220) can indicate that a user has presented the VSP card at a point of sale terminal in an attempt to purchase a good or service. In this example, the VSP card can be linked with the purchasing card, and the point of sale terminal communicates with the purchasing card issuer via the acquirer or issuer network to request approval for the transaction and to charge the transaction to the purchasing card. The VSPC server can identify the transaction (ACT 220) by receiving a communication from the point of sale terminal or from the purchasing card issuer. The transaction can be identified (ACT 220) by receiving the request for approval for the transaction from the point of sale terminal, from the purchasing card issuer, by receiving a response from the purchasing card issuer to the point of sale terminal, or by receiving a separate transmission at the VSPC server from the point of sale terminal or from the purchasing card issuer. The separate communication in this example can notify the VSPC server that a user has presented the VSP card at a point of sale terminal.

In some implementations, the method 200 includes an act of determining that the transaction satisfies the restriction criteria (ACT 225). For example, the VSPC server can compare the transaction and the circumstances under which the transaction was made (e.g., the time, location, monetary value, merchant, or time period since the most recent previous transaction) with the restriction criteria. When the transaction satisfies the restriction criteria, the VSPC server can determine that the restriction criterion is satisfied (ACT 225).

Responsive to a determination that the restriction criteria is satisfied (ACT 225) the method 200 can include an act of authorizing the transaction (ACT 230). For example, the VSPC server can communicate an authorization notification to the point of sale terminal or to the purchasing card issuer indicating that the VSP card is eligible to make the transaction on behalf of the purchasing card. In some implementations, the VSPC server can authorize the transaction (ACT 230) based on characteristics of the purchasing card, such as the billing cycle, interest rate, or benefits or awards associated with use of the purchasing card. For example, a VSP card can be linked with more than one purchasing card. The VSPC server can receive purchasing card characteristic information (e.g., from the purchasing card issuer) of at least one purchasing card and can select one of the purchasing cards linked with the VSP card to be used for a purchase based on the availability or unavailability of a characteristic.

In one implementation, the transaction is authorized (ACT 230) by selecting an acquirer or issuer network from a group of networks based on a characteristic of one of a group of purchasing cards. For example, when a purchasing card is selected based at least in part on a characteristic of the purchasing card, the point of sale terminal can communicate with the purchasing card issuer using the acquirer or issuer network associated with that purchasing card issuer. In some implementations, the method 200 authorizes the transaction (ACT 230) by providing a notification that the restriction criteria is satisfied (ACT 225). In this example, the notification authorizes continued processing of the transaction by the purchasing card issuer or the point of sale terminal. For example, the purchasing card issuer may proceed to ultimately authorize or decline the transaction after the VSPC server determines that the restriction criteria is satisfied (ACT 225) and provides a notification (ACT 230) to that effect.

In some implementations, the method 200 includes an act of determining that the transaction fails to satisfy the restriction criteria (ACT 235). For example, the VSPC server can determine that the transaction at the point of sale terminal, or a term, condition, or circumstance of the transaction does not satisfy at least one restriction criterion (ACT 235). In one implementation, responsive to a determination that the transaction fails to satisfy restriction criteria (ACT 235) the method 200 rejects the transaction (ACT 240). For example, the VSPC server can reject the transaction (ACT 240) by providing a notification to the purchasing card issuer or to the point of sale terminal that the transaction should be rejected or declined because at least one restriction criterion is not satisfied or because the VSP card is expired or otherwise invalid.

In some implementations, the method 200 includes an act of recording information in a data storage unit (ACT 245). For example, information about the VSP cards, VSP card links with purchasing cards, restriction criteria, user identification information, and information about authorized or declined transactions, historical VSP card usage information, or account balances can be stored in a database (ACT 245) associated with the VSPC server. This information can be stored in a database (ACT 245) as part of a user account that identifies a user authorized to make purchases with the VSP card. Information recorded in the database can be retrieved by the VSPC server to determine whether or not a VSP card can be used to purchase a good or service.

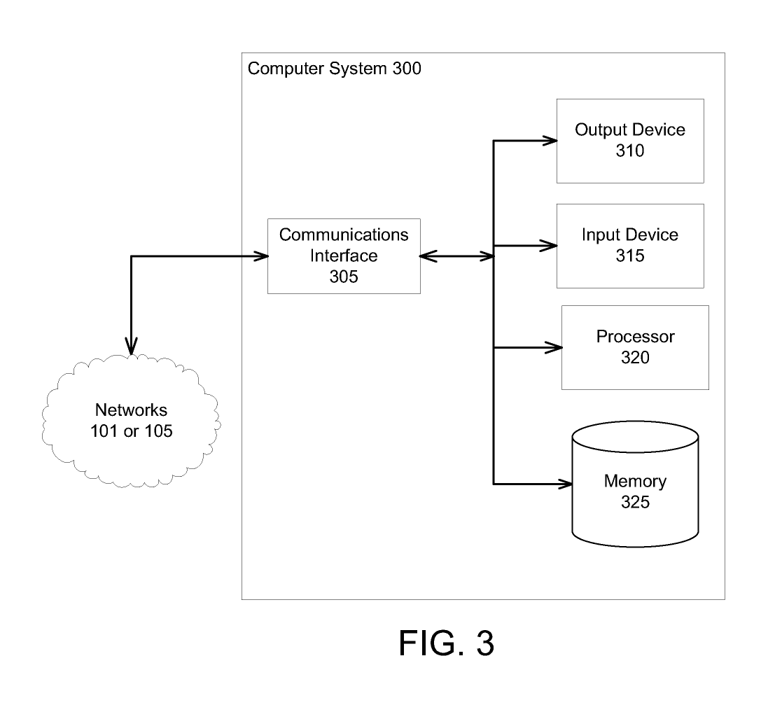

FIG. 3 shows the general architecture of an illustrative computer system 300 that may be employed to implement any of the computer systems discussed herein (including the system 100 and its components such as the VSPC server 120) in accordance with some implementations. The computer system 300 can be used to process transactions via a computer network such as the acquirer network 101, the issuer network 105 to authorize or decline VSP card purchases with the VSP card linked to at least one credit card or other purchasing card. The computer system 300 of FIG. 3 comprises one or more processors 320 communicatively coupled to memory 325, one or more communications interfaces 305, and one or more output devices 310 (e.g., one or more display units) and one or more input devices 315. The processors 320 can be included in the VSPC server 120 or the other components of the system 100 such as the point of sale terminal 110 or the purchasing card issuer 115.

In the computer system 300 of FIG. 3, the memory 325 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, VSPC server 120 or the database 125 can include the memory 325 to store identification information, restriction criteria, and other information about the VSP card and purchasing cards that can be linked with the VSP card. This information can be stored in the memory 325 as part of a user account. The memory 325 can include the database 125. The processor(s) 320 shown in FIG. 3 may be used to execute instructions stored in the memory 325 and, in so doing, also may read from or write to the memory various information processed and or generated pursuant to execution of the instructions.

The processor 320 of the computer system 300 shown in FIG. 3 also may be communicatively coupled to or control the communications interface(s) 305 to transmit or receive various information pursuant to execution of instructions. For example, the communications interface(s) 305 may be coupled to a wired or wireless network, bus, or other communication means and may therefore allow the computer system 300 to transmit information to and/or receive information from other devices (e.g., other computing devices or computer systems). With reference to the system 100 of FIG. 1, one or more communications interfaces facilitate information flow between the components of the system 100. In some implementations, the communications interface(s) may be configured (e.g., via various hardware components or software components) to provide an access portal to at least some aspects of the computer system 300.

The output devices 310 of the computer system 300 shown in FIG. 3 may be provided, for example, to allow various information to be viewed or otherwise perceived in connection with execution of the instructions. The input device(s) 315 may be provided, for example, to allow a user to make manual adjustments, make selections, enter data or various other information such as a VSP card number, or interact in any of a variety of manners with the processor during execution of the instructions.

Embodiments of the subject matter and the operations described herein can be implemented in digital electronic circuitry, or in computer software embodied on a storage medium, tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms data processing apparatus, computing device, or server encompass any apparatus, device, and machine for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The VSPC server 120 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. These processors can be included in the VSPC server 120. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, smart phone, tablet computer, personal digital assistant (PDA), mobile audio or video player, game console, Global Positioning System (GPS) receiver, or a portable storage device (e.g., a universal serial bus (USB) flash drive), for example. Devices suitable for storing computer program instructions and data include non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), plasma, or LCD (liquid crystal display) monitor, for displaying information to the user and a keyboard, card reader, or pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, magnetic strip, bar code, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 300 or system 100 can include clients and servers. For example, the VSPC server 120 can include one or more servers in one or more data centers or server farms. A client and server are generally remote from each other and typically interact through a communication network. The relationship of client and server arises by virtue of computer programs running on the respective computers and having a client-server relationship to each other. In some embodiments, a server transmits data (e.g., indications authorizing or declining VSP card transactions) to a client device (e.g., for purposes of evaluating VSP card transactions). Data generated at the client device (e.g., a result of the user interaction with the point of sale terminal 110) can be received from the client device at the server.

While this specification contains many specific implementation details, these should not be construed as limitations on the scope of any inventions or of what may be claimed, but rather as descriptions of features of example embodiments of the systems and methods described herein. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, operations depicted in the drawings should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. For example, the VSPC server 120 and the purchasing card issuer 115 can be a single module, a logic device having one or more processing circuits, or the VSPC server 120 can be a virtual server executing on a server or other computing device of the purchasing card issuer 115.

Having now described some illustrative implementations and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one embodiment are not intended to be excluded from a similar role in other implementations or embodiments.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementations,” “an alternate implementation,” “various implementation,” “one implementation” or the like are not necessarily mutually exclusive and are intended to indicate that a particular feature, structure, or characteristic described in connection with the embodiment may be included in at least one implementation or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, the VSPC server and the purchasing card issuer can be owned or operated by the same entity, such as a credit card company or financial institution. Further, the VSP card need not by a physical card and may be a virtual card represented for example by an account number stored in a memory unit accessible by a smart phone or other computing device. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of processing transactions via a computer network, comprising:
receiving, at a virtual specific purchasing card server, a registration request to activate a virtual specific purchasing card, wherein the registration request identifies the virtual specific purchasing card and identifies a purchasing card associated with at least one of an acquirer network and an issuer network;
linking the virtual specific purchasing card with a purchasing card associated with at least one of the acquirer network and the issuer network;
obtaining restriction criteria of the virtual specific purchasing card, wherein the restriction criteria includes a time restriction and at least one of a subject matter restriction, a geographic restriction, a product restriction, a service restriction, a merchant restriction, a value restriction, a frequency restriction, and a notification restriction;
identifying a transaction corresponding to the virtual specific purchasing card; and
determining that the transaction satisfies the restriction criteria.

2. The computer implemented method of claim 1, further comprising:
identifying a second transaction corresponding to the virtual specific purchasing card;
determining that the second transaction fails to satisfy the restriction criteria;
generating a notification indicating that the second transaction fails to satisfy the restriction criteria; and
recording information corresponding to at least one of the transaction and the second transaction in a data storage unit.

3. The computer implemented method of claim 1, further comprising:
adjusting the restriction criteria responsive to an adjustment request received by the virtual specific purchasing card server via the computer network.

4. The computer implemented method of claim 1, wherein the issuer network is a first issuer network and the purchasing card is a first purchasing card, further comprising:
linking the virtual specific purchasing card with a second purchasing card associated with a second issuer network;
identifying a characteristic available via the purchasing card and the first issuer network;
determining that the characteristic is unavailable via the second purchasing card and the second issuer network; and
authorizing the transaction via the first issuer network based on availability of the characteristic.

5. The computer implemented method of claim 1, wherein the virtual specific purchasing card is a first virtual specific purchasing card, further comprising:
linking a plurality of virtual specific purchasing cards including the first virtual specific purchasing card with the issuer network; and
obtaining restriction criteria of the plurality of virtual specific purchasing cards, wherein the restriction criteria of the plurality of virtual specific purchasing cards is equivalent to the restriction criteria of the first virtual specific purchasing card.

6. The computer implemented method of claim 1, further comprising:
linking the virtual specific purchasing card with a plurality of purchasing cards, each purchasing card associated with a different issuer network; and
selecting a selected one of the plurality of issuer networks to process the transaction based on a characteristic associated with the one of the plurality of purchasing cards.

7. The computer implemented method of claim 1, further comprising:
providing an authorization notification to at least one of a point of sale terminal and a purchasing card issuer via the issuer network, wherein the authorization notification authorizes continued processing of the transaction.

8. The computer implemented method of claim 1, further comprising:
providing an authorization notification to at least one of a point of sale terminal and a purchasing card issuer via the acquirer network, wherein the authorization notification authorizes continued processing of the transaction.

9. The computer implemented method of claim 1, further comprising:
identifying a second transaction corresponding to the virtual specific purchasing card; and
providing a rejection notification to at least one of a point of sale terminal and a purchasing card issuer via the issuer network, wherein the rejection notification declines the transaction.

10. A system of processing transactions via a computer network, comprising:
a virtual specific purchasing card server configured to communicate with at least one of an acquirer network and an issuer network and with a data storage unit, the virtual specific purchasing card server further configured to:
receive a registration request to activate a virtual specific purchasing card;
link the virtual specific purchasing card with a purchasing card associated with at least one of the acquirer network and the issuer network;
obtain restriction criteria of the virtual specific purchasing card, wherein the restriction criteria includes a time restriction and at least one of a subject matter restriction, a geographic restriction, a product restriction, a service restriction, a merchant restriction, a value restriction, a frequency restriction, and a notification restriction;
identify a transaction corresponding to the virtual specific purchasing card;
determine that the transaction satisfies the restriction criteria; and
provide information corresponding to the transaction to the data storage unit.

11. The system of claim 10, further comprising the virtual specific purchasing card server configured to:
identify a second transaction corresponding to the virtual specific purchasing card;
determine that the second transaction fails to satisfy the restriction criteria; and
generate a notification indicating that the second transaction fails to satisfy the restriction criteria.

12. The system of claim 10, further comprising the virtual specific purchasing card server configured to:
adjust the restriction criteria responsive to an adjustment request received by the virtual specific purchasing card server via the computer network.

13. The system of claim 10, wherein the issuer network is a first issuer network and the purchasing card is a first purchasing card, further comprising the virtual specific purchasing card server configured to:
link the virtual specific purchasing card with a second purchasing card associated with a second issuer network;
identify a characteristic available via the purchasing card and the first issuer network;
determine that the characteristic is unavailable via the second purchasing card and the second issuer network; and
authorize the transaction via the first issuer network based on availability of the characteristic.

14. The system of claim 10, wherein the virtual specific purchasing card is a first virtual specific purchasing card, further comprising the virtual specific purchasing card server configured to:
link a plurality of virtual specific purchasing cards including the first virtual specific purchasing card with the issuer network; and
obtain restriction criteria of the plurality of virtual specific purchasing cards, wherein the restriction criteria of the plurality of virtual specific purchasing cards is equivalent to the restriction criteria of the first virtual specific purchasing card.

15. The system of claim 10, further comprising the virtual specific purchasing card server configured to:
link the virtual specific purchasing card with a plurality of purchasing cards, each purchasing card associated with a different issuer network; and
select a selected one of the plurality of issuer networks to process the transaction based on a characteristic associated with one of the plurality of purchasing cards.

16. The system of claim 10, further comprising the virtual specific purchasing card server configured to:
provide an authorization notification to at least one of a point of sale terminal and a purchasing card issuer via the issuer network, wherein the authorization notification authorizes continued processing of the transaction.

17. The system of claim 10, further comprising the virtual specific purchasing card server configured to:
identify a second transaction corresponding to the virtual specific purchasing card; and
provide a rejection notification to at least one of a point of sale terminal and a purchasing card issuer via the issuer network, wherein the rejection notification declines the transaction.

18. A computer readable storage medium having instructions to process transactions via a computer network, the instructions comprising instructions to:
receive a registration request to activate a virtual specific purchasing card;
link the virtual specific purchasing card with a purchasing card associated with at least one of an acquirer network and an issuer network;
obtain restriction criteria of the virtual specific purchasing card, wherein the restriction criteria includes a time restriction and at least one of a subject matter restriction, a geographic restriction, a product restriction, a service restriction, a merchant restriction, a value restriction, a frequency restriction, and a notification restriction;
identify a transaction corresponding to the virtual specific purchasing card;
determine that the transaction satisfies the restriction criteria; and
record information corresponding to the transaction in a data storage unit.

19. The computer readable storage medium of claim 18, further comprising instructions to:
identify a second transaction corresponding to the virtual specific purchasing card;
determine that the second transaction fails to satisfy the restriction criteria; and
generate a notification indicating that the second transaction fails to satisfy the restriction criteria.

20. The computer readable storage medium of claim 18, wherein the issuer network is a first issuer network and the purchasing card is a first purchasing card, further comprising instructions to:
linking the virtual specific purchasing card with a second purchasing card associated with a second issuer network;
identifying a characteristic available via the purchasing card and the first issuer network;
determining that the characteristic is unavailable via the second purchasing card and the second issuer network; and
authorizing the transaction via the first issuer network based on availability of the characteristic.

21. The computer readable storage medium of claim 18, wherein the virtual specific purchasing card is a first virtual specific purchasing card, further comprising instructions to:
link a plurality of virtual specific purchasing cards including the first virtual specific purchasing card with the issuer network; and
obtain restriction criteria of the plurality of virtual specific purchasing cards, wherein the restriction criteria of the plurality of virtual specific purchasing cards is equivalent to the restriction criteria of the first virtual specific purchasing card.
